(19) United States
(12) Patent Application Publication
(10) Pub. No.: US 2020/0335782 A1
(43) Pub. Date: Oct. 22, 2020

(54) A CATHODE ACTIVE MATERIAL FOR LITHIUM SECONDARY BATTERY AND A LITHIUM SECONDARY BATTERY COMPRISING THEREOF

(71) Applicant: L&F CO., LTD., Daegu (KR)

(72) Inventors: Ji Woo OH, Daegu (KR); Hee won JUNG, Daegu (KR); Jun Ho SHIN, Daegu (KR); Su An CHOI, Daegu (KR); Sang Hoon JEON, Daegu (KR); Ji Sun AN, Daegu (KR)

(21) Appl. No.: 16/760,103

(22) PCT Filed: Nov. 28, 2017
(86) PCT No.: PCT/KR2017/013688

§ 371 Date: May 12, 2020

(30) Foreign Application Priority Data
Oct. 30, 2017 (KR) 10-2017-0142603

(51) Int. Cl. H01M 4/525; H01M 4/505; H01M 10/0525; H01M 4/38

(52) U.S. Cl. CPC H01M 4/525; H01M 4/38; H01M 10/0525; H01M 4/505

(57) ABSTRACT

The present invention relates to a cathode active material for a lithium secondary battery having improved output characteristics at a low temperature, and to a lithium secondary battery comprising the same, the cathode active material comprising: a lithium metal oxide comprising Ni, Co and Mn to enable reversible intercalation and de-intercalation of lithium, wherein the lithium metal oxide is doped with a dopant (M) to substitute any one or more elements of Ni, Co and Mn, and the lithium metal oxide has a c-axis lattice constant value of 14.20 Å or more and 14.30 Å or less.

### CROSS-REFERENCE TO RELATED APPLICATION

This application claims priority to and the benefit of Korean Patent Application No. 10-2017-0142603 filed in the Korean Intellectual Property Office on Oct. 30, 2017, the entire contents of which are incorporated herein by reference.

### BACKGROUND OF THE INVENTION

### (a) Field of the Invention

The present invention relates to a cathode active material for a lithium secondary battery and a lithium secondary battery comprising the same, and more particularly, relates to a cathode active material for a lithium secondary battery with improved power characteristics at low temperature and a lithium secondary battery comprising the same.

### (b) Description of the Related Art

Recently, portable device applications require both high performance and large capacity of batteries used as power sources according to the trends with miniaturization and lightweight.

The batteries generates electricity by working on the oxidation and reduction reaction of an electrolyte with two substances called cathode and anode. The Lithium ion battery is representative example that cathode and anode generate electricity by changing of chemical potential during lithium ion intercalation/de-intercalation.

The lithium secondary battery is manufactured by using a material capable of reversible intercalation/de-intercalation of lithium ions as a cathode active material and an anode active material, and filling an organic electrolyte solution or a polymer electrolyte solution between the cathode and the anode.

A lithium composite metal compound is used as a cathode active material for a lithium secondary battery. For example, composite metal oxides such as LiCoO₂, LiMn₂O₄, LiNiO₂, LiNiₓCo_{y}Mn_{z}O₂, LiMn₂O₄, and the like have been researched.

Among cathode active materials, LiNiₓCo_{y}Mn_{z}O₂, NCM-based cathode active material has the same layer structure as LCO-based cathode active material, which is largely used recently because it has a similar capacity and operating voltage per volume compared to the LCO-based cathode active material, and the content of Co is low so that the price can be lowered.

Low temperature power characteristic is one of the important factor of the Lithium ion batteries performance. The applicant has continued to study the low temperature power characteristic, as results, it was confirmed that c-axis lattice constant and powder resistivity concerning the structure of NCM-based cathode active material was related to the low temperature power characteristic.

The above information disclosed in this Background section is only for enhancement of understanding of the background of the invention and therefore it may contain information that does not form the prior art that is already known in this country to a person of ordinary skill in the art.

### SUMMARY OF THE INVENTION

### Technical Problem

The present invention provides a NCM-based cathode active material for a lithium secondary battery with improved power characteristics at low temperature by adjusting the c-axis lattice constant and a lithium secondary battery comprising the same.

### Technical Solution

A cathode active material for a lithium secondary battery according to an embodiment of the present invention comprises: a lithium metal oxide comprising Ni, Co and Mn enable to react reversible intercalation and de-intercalation of lithium, wherein the lithium metal oxide is doped with a dopant (M) to substitute any one or more elements of Ni, Co and Mn, and the lithium metal oxide has a c-axis lattice constant value of 14.20 Å or more and 14.30 Å or less.

Wherein M is any one of metals selected from the group consisting of Ti, Zr, Mg, V, Zn, Mo, Ni, Co and Mn.

It is preferable that the lithium metal oxide has a powder resistivity value of 21,000 Ω·cm or more and 23,900 Ω·cm or less.

It is preferable that the dopant (M) is Ti.

It is preferable that the lithium metal oxide has a Li/Me molar ratio of 1.00 or more and 1.15 or less, and doping amount of the Ti is 5,000 ppm or more and 10,000 ppm or less based on the weight of the lithium metal oxide.

It is more preferable that the lithium metal oxide has a Li/Me molar ratio of 1.04 or more and 1.08 or less.

In particular, it is preferable that the lithium metal oxide has a Li/Me molar ratio of 1.06, and the lithium metal oxide has a c-axis lattice constant value of 14.210 Å or more and 14.2176 Å or less.

It is preferable that the lithium metal oxide has the average particle size (D50) of 2 μm or more and 5 μm or less.

Meanwhile, A lithium secondary battery according to an embodiment of the present invention comprises: a cathode comprising the cathode active material for a lithium secondary battery comprising a lithium metal oxide comprising Ni, Co and Mn enable to react reversible intercalation and de-intercalation of lithium, wherein the lithium metal oxide is doped with a dopant (M) to substitute any one or more elements of Ni, Co and Mn, and the lithium metal oxide has a c-axis lattice constant value of 14.20 Å or more and 14.30 Å or less; an anode comprising an anode active material; and an electrolyte.

### Advantageous Effects

According to an embodiment of the present invention, by substituting a metal in a compound capable of reversible intercalation and de-intercalation of lithium with another metal, the c-axis lattice constant of the lithium metal oxide may be increased and the powder resistivity of the lithium metal oxide also may be increased, thereby having the effect of improving the power characteristics at low temperatures.

### BRIEF DESCRIPTION OF THE DRAWINGS

FIG. 1 is a graph comparing powder resistivity values of Examples and Comparative Examples according to the present invention,

FIG. 2 is a graph comparing resistance values at low temperatures in Examples and Comparative Examples according to the present invention.

FIG. 3 is a graph of a value obtained by converting the resistance value of FIG. 2 into a power.

### DETAILED DESCRIPTION OF THE EMBODIMENTS

Embodiments of the present invention will be described in more detail with reference to the attached drawings. However, the present invention is not limited to the embodiments disclosed below, but will be implemented in various different forms. Only the embodiments allow the disclosure of the present invention to be complete, and are provided to inform the scope of the invention to those skilled in the art completely.

A cathode active material for a lithium secondary battery according to an embodiment of the present invention is an active material forming a cathode applied to a lithium secondary battery, which may comprise a lithium metal oxide. Where, the lithium secondary battery comprises a cathode comprising a cathode active material; an anode comprising an anode active material; and an electrolyte.

The lithium metal oxide may comprise Ni to enable reversible intercalation and de-intercalation of lithium. Further, it may further comprise Co and Mn, and may consist of a NCM-based (Ni composite oxide) lithium oxide which is in one form of the compound formed accordingly.

The NCM-based lithium oxide forming the lithium metal oxide may be a lithium metal composite oxide according to [Chemical Formula 1] below.

Li_{α}[(NiₓM1_{y})M2ₐM3_{b}]O_{2-β}A_{β} [Chemical Formula 1]

Where, M1 is at least one selected from Co, and Mn, M2 is Ti,

M3 is at least one selected from Al, Mg, Zr, B, Ca, Nb, Mn, Co, Ge, Ba, V, and Cr, A is at least one elements selected from P, F, S, and B.

Further, it satisfies 1.0≤α≤1.2, 0≤β≤1, 0<x≤1.0, 0≤y≤1, 0.0005≤a≤0.05, and 0≤b≤0.05.

Meanwhile, any one or more elements of Ni, Co, and Mn among the elements forming the lithium metal oxide are doped while being substituted with a dopant (M) to increase the c-axis lattice constant of the lithium metal oxide.

At this time, the dopant (M) is selected from the group consisting of Ti, Zr, Mg, V, Zn, Mo, Ni, Co and Mn. For example, it is preferable to select Ti as the dopant (M).

In the lithium metal oxide, the c-axis lattice constant value increases as decreasing Li/Me molar ratio, and as increasing dopant (M) contents at the same Li/Me molar ratio.

Here, Me means all metals in a compound capable of reversible intercalation and de-intercalation of lithium.

As a side note, the smaller Li/Me molar ratio, the higher probability to position Ni, Co, and Mn transition metals at the 3a site in the structure which likely increases the c-axis lattice constant value.

Further, in case of the same Li/Me molar ratio, the higher content of dopant (M), the higher probability to position dopant at the 3a site affecting the c-axis increase in the structure. Thereby increasing the c-axis lattice constant results from the decreasing the bonding distance with oxygen in the transition metal layer.

The lithium metal oxide has a c-axis lattice constant value of 14.20 Å or higher and 14.30 Å or less to improve low-temperature characteristics. Preferably, the lithium metal oxide maintains a Li/Me molar ratio in a range of 1.00 or more and 1.15 or less, and at this time, the dopant contents based on the weight of the lithium metal oxide are 5,000 ppm or more and 10,000 ppm or less. Therefore, the lithium metal oxide has a c-axis lattice constant value of 14.20 Å or more and 14.30 Å or less.

Even if the same element is applied as dopant, since the value of c-axis lattice constant before doping is different depending on the content of Ni in the NCM-based lithium oxide, in case that the dopant proposed in the embodiment is used for the composition of the NCM-based lithium oxide, the value of c-axis within the range of 14.20 Å or more and 14.30 Å or less is acceptable.

For example, by maintaining the Li/Me molar ratio of the lithium metal oxide at 1.06 and doping the dopant Ti by 5,000 ppm or more and 10,000 ppm or less, the c-axis lattice constant value of the lithium metal oxide may be formed of 14.2101 Å or more, and 14.2176 Å or less. The lithium metal oxides are not limited by the provided the Li/Me molar ratio but could adjust the Li/Me ratio and amount of dopant contents within the setting range in order to maintain an optimal c-axis lattice constant range.

On the other hand, as the lithium metal oxide is doped with one or more elements of Ni, Co, and Mn being substituted with Ti as a dopant (M), the powder resistivity increases.

As a side note, when the lithium metal oxide is doped with the Ti dopant, Ti increases the bonding strength with adjacent oxygen in the structure by increasing the band gap, and accordingly, increase of the powder resistivity results from the decrease of the conductivity.

Therefore, in an embodiment according to the present invention, in order to expect an improvement of low-temperature power by increasing the extent of the c-axis lattice constant and increasing the powder resistivity value, the doping amount of dopant is proposed in the range of 5,000 ppm or more, and 10,000 ppm or less based on the weight of lithium metal oxide, and the range of the c-axis lattice constant value of 14.21 Å or more, and 14.30 Å or less, preferably 14.2101 Å or more, and 14.217 Å or less, is achieved, and the range of the powder resistivity value of 21,024 Ω·cm or more, and 23,900 Ω·cm or less, is achieved.

Meanwhile, it is preferable that the content of Ni in the metal element comprised in the lithium metal oxide is 50% or less. The reason is that in general, the higher the content of Ni in the NCM-based lithium oxide is accompanied by a structural power deterioration, it is preferable to limit the content of Ni in the metal element comprised in the lithium metal oxide to 50% or less for high power.

Further, it is preferable that the average particle diameter (D50) of the lithium metal oxide is 2 μm or more and 5 μm or less.

In addition, it is preferable that the lithium metal oxide is HB type (High BET type).

Wherein the HB type refers to a particle type comprising a structure capable of increasing a specific surface area compared to a particle having a general dense structure, and examples of the particles preferably comprise a structure in which is the other area of the outer surface of the particles to contact with the electrolyte solution, such as inner pores, micro pores, tunnels, and center holes is added. At this time, it is preferable that the specific surface area is 0.5 m²/g or more and 5.0 m²/g or less.

Meanwhile, the cathode active material according to an embodiment of the present invention may be used in a cathode of a lithium secondary battery. The lithium secondary battery comprises an anode comprising an anode active material together with a cathode; and an electrolyte.

The cathode is prepared by mixing a cathode active material according to an embodiment of the present invention, a conductive material, a binder, and a solvent to prepare a cathode active material composition, and then directly coating and drying on the current collector. Alternatively, it can be produced by casting the cathode active material composition on a separate support and then laminating the film obtained by peeling from the support on a current collector.

The binder serves to appropriately bind cathode active material particles to each other and appropriately bind the cathode active material to the current collector, and as a representative example of the binder, polyvinylalcohol, carboxymethylcellulose, hydroxypropylcellulose, polyvinylchloride, carboxylated polyvinylchloride, polyvinylfluoride, a polymer comprising ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, nylon, or the like, may be used, but the binder is not limited thereto.

The conductive material is used in order to impart conductivity to the electrode, and any material may be used as long as it does not cause chemical changes in a battery to be configured and is an electron-conductive material, and as examples, natural graphite, artificial graphite, carbon black, acetylene black, Ketjen black, carbon fiber, metal powder and metal fiber of copper, nickel, aluminum, silver, or the like, may be used, and one or more conductive materials such as polyphenylene derivatives may be mixed and used.

As a material of the current collector, Al may be used, but is not limited thereto.

The anode and the cathode may be manufactured by mixing active materials, the conductive material, and the binder in a solvent to prepare active material compositions, and applying the compositions on the current collector, respectively. Since a method of manufacturing an electrode as described above is well-known in the art, a detailed description thereof will be omitted in the present specification. As the solvent, N-methylpyrrolidone, or the like, may be used, but the solvent is not limited thereto.

### Detailed Description of the Embodiments

Hereinafter, the present invention will be described through examples and comparative examples of the present invention.

### <Experiment 1> Experiment of the Relationship Between Li/Me Molar Ratio and Doping Amount and c-Axis Lattice Constant Value

In order to examine the change in the c-axis lattice constant according to the Li/Me molar ratio and doping amount of the lithium metal oxide, the c-axis lattice constant value was measured while changing the Li/Me molar ratio and doping amount as shown in Table 1 below. At this time, Li source was Li₂CO₃, and Me precursor was a Ni_{0.35}Co_{0.37}Mn_{0.28}(OH)₂ compound, and TiO₂ was used as a dopant (M) for doping Ti. However, the sources for these elements are not limited as in this experiment, and may be in the form of other compounds commonly used by those skilled in the art. Further, the sintering conditions vary according to the type and environment of the sintering furnace, but the conditions of the sintering holding temperature of 900 to 1000° C., and the sintering holding time of 10 to 20 hours that may form a layered crystal structure without impurities are preferable.

TABLE 1

| | Li/Me Molar | Doping amount | C-axis lattice constant |
|---|---|---|---|
| Classification | ratio | (ppm) | value (Å) |
| Comparative | 1.01 | — | 14.2247 |
| Example 1 | | | |
| Comparative | 1.04 | — | 14.2058 |
| Example 2 | | | |
| Comparative | 1.06 | — | 14.1985 |
| Example 3 | | | |
| Comparative | 1.08 | — | 14.1961 |
| Example 4 | | | |
| Comparative | 1.12 | — | 14.1921 |
| Example 5 | | | |
| Comparative | 1.06 | 200 | 14.2086 |
| Example 6 | | | |
| Comparative | 1.06 | 3,000 | 14.2098 |
| Example 7 | | | |
| Example 1 | 1.06 | 5,000 | 14.2101 |
| Example 2 | 1.06 | 10,000 | 14.2176 |

As may be confirmed from Table 1, it was confirmed that the c-axis lattice constant value of the lithium metal oxide tends to increase as the molar ratio of Li/Me decreases, and as the doping amount of the dopant (M) increases under the same condition of the molar ratio of Li/Me. In addition, in order to satisfy a c-axis lattice constant value which is limited for improving low-temperature characteristics, it was confirmed that it is preferable to maintain the molar ratio of Li/Me at 1.06, and maintain the doping amount of the dopant (M) is 10,000 ppm or less while being 200 ppm or more according to the molar ratio of Li/Me. More preferably, it was confirmed that it is preferable to maintain 10,000 ppm or less while being 5,000 ppm or more.

### <Experiment 2> Experiment on the Relationship Between Li/Me Molar Ratio and Doping Amount and Powder Resistivity Value

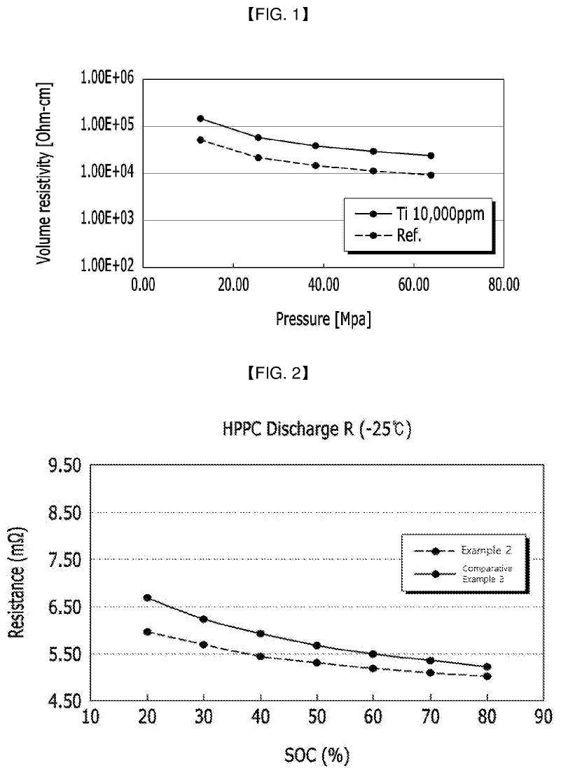

In order to examine the change in powder resistivity according to the Li/Me molar ratio and doping amount of lithium metal oxide, the powder resistivity value was measured while changing the Li/Me molar ratio and doping amount as shown in Table 2 below, and the results were shown in Table 2 and FIG. 1. At this time, Ti was used as the dopant (M). At this time, FIG. 1 shows the powder resistivity value for each pressure of Comparative Example 3 and Example 2 according to the present invention without doping the dopant.

TABLE 2

| | | Doping | Powder resistivity |
|---|---|---|---|
| | Li/Me Molar | amount | value |
| Classification | ratio | (ppm) | (Ohm-cm) |
| Comparative | 1.06 | — | 9,225 |
| Example 3 | | | |
| Comparative | 1.06 | 3,000 | 17,450 |
| Example 7 | | | |
| Example 1 | 1.06 | 5,000 | 21,024 |
| Example 2 | 1.06 | 10,000 | 23,900 |

As may be confirmed from Table 2 and FIG. 1, it was confirmed that the powder resistivity value of the lithium metal oxide tends to increase as the doping amount of the dopant (M) increases under the condition of certain molar ratio of Li/Me. In addition, in order to satisfy powder resistivity value which is limited for improving low-temperature characteristics, it was confirmed that it is preferable to maintain the molar ratio of Li/Me at 1.06, and maintain the doping amount of the dopant (M) is 10,000 ppm or less while being 5,000 ppm or more according to the molar ratio of Li/Me.

Therefore, in order to satisfy both a c-axis lattice constant value and powder resistivity value which are limited for improving low-temperature characteristics, it was confirmed that it is preferable to maintain the molar ratio of Li/Me at 1.06, and maintain the doping amount of the dopant (M) is 10,000 ppm or less while being 5,000 ppm or more according to the molar ratio of Li/Me.

### <Experiment 3> Experiment on the Relationship Between Low-Temperature (−25° C.) Power Characteristics According to the Composite Effect of Increasing of C-Axis Lattice Constant and Powder Resistivity

In order to examine the change in power characteristics at low temperature (−25° C.) according to the c-axis lattice constant of lithium metal oxide, resistance measurement of a lithium secondary battery using HPPC was performed.

HPPC (hybrid pulse power characterization) test was performed to measure the resistance of the lithium secondary battery manufactured according to each SOC.

It was charged from SOC 10 to full charge (SOC=100) to 4.15 Vat 1 C (30 mA), and after stabilizing the battery for an hour each, the resistance of the lithium secondary battery was measured according to the HPPC test method, while discharging the battery from SOC 100 to 10, then after stabilizing the battery for an hour each, the resistance of the lithium secondary battery was measured by the HPPC test method for each SOC step, and the results are shown in Table 3 below and FIG. 3.

TABLE 3

| | | | Comparative | | |
|---|---|---|---|---|---|
| | Resistance | SOC | Example 3 | Example 2 | Δ |
| | [mΩ] | (%) | [mΩ] | [mΩ] | [%] |
| Low temp. | Charge R | 80 | 4.75 | 4.88 | Δ2.7 |
| (−25° C.) | Charge R | 50 | 4.88 | 4.75 | ▾2.7 |
| | | 20 | 4.73 | 4.62 | ▾2.3 |
| | Discharge R | 80 | 5.22 | 5.02 | ▾3.8 |
| | | 50 | 5.67 | 5.31 | ▾6.3 |
| | | 20 | 6.69 | 5.96 | ▾10.9 |

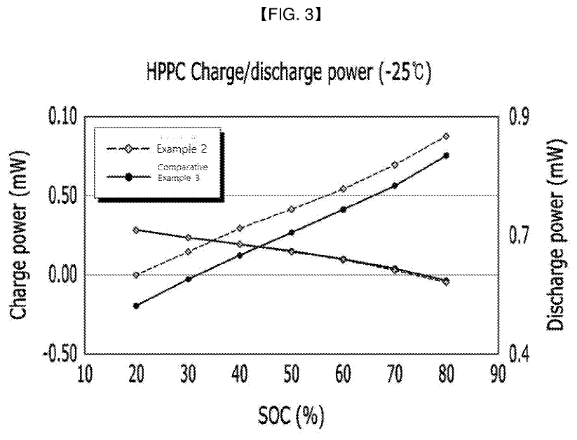

As may be confirmed from Table 3 and FIG. 2 and FIG. 3, when charging at low temperature (−25° C.), in case of SOC 80, it was confirmed that the resistance slightly increased in Example 2 compared to Comparative Example 3, but when charging and discharging in the rest of the SOC at low temperature (−25° C.), it was confirmed that the resistance decreased in Example 2 compared to Comparative Example 3.

Therefore, it was confirmed that the c-axis lattice constant value is increased by doping the dopant (M) under a certain condition of maintaining molar ratio of Li/Me, and accordingly the low-temperature power characteristics of the lithium secondary battery are increased.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

1. A cathode active material for a lithium secondary battery comprising:
a lithium metal oxide comprising Ni, Co and Mn to enable reversible intercalation and de-intercalation of lithium,
wherein the lithium metal oxide is doped with a dopant (M) to substitute any one or more elements of Ni, Co and Mn, and
the lithium metal oxide has a c-axis lattice constant value of 14.20 Å or more and 14.30 Å or less,
wherein M is any one of metals selected from the group consisting of Ti, Zr, Mg, V, Zn, Mo, Ni, Co and Mn.

2. The cathode active material for a lithium secondary battery of claim 1, wherein:
the lithium metal oxide has a powder resistivity value of 21,000 Ω·cm or more and 23,900 Ω·cm or less.

3. The cathode active material for a lithium secondary battery of claim 1, wherein:
the dopant (M) is Ti.

4. The cathode active material for a lithium secondary battery of claim 3, wherein:
the lithium metal oxide has a Li/Me molar ratio of 1.00 or more and 1.15 or less, and
doping amount of the Ti is 5,000 ppm or more and 10,000 ppm or less on the basis of the weight of the lithium metal oxide,
wherein Me means all metals in the compound capable of reversible intercalation and de-intercalation of lithium.

5. The cathode active material for a lithium secondary battery of claim 4, wherein:
the lithium metal oxide has a Li/Me molar ratio of 1.04 or more and 1.08 or less.

6. The cathode active material for a lithium secondary battery of claim 4, wherein:
the lithium metal oxide has a Li/Me molar ratio of 1.06, and
the lithium metal oxide has a c-axis lattice constant value of 14.210 Å or more and 14.2176 Å or less.

7. The cathode active material for a lithium secondary battery of claim 1, wherein:
the lithium metal oxide has an average particle diameter (D50) of 2 μm or more and 5 μm or less.

8. The cathode active material for a lithium secondary battery of claim 1, wherein:
the lithium metal oxide is HB (High BET) type.

9. A lithium secondary battery comprising:
a cathode comprising the cathode active material for a lithium secondary battery according to claim 1;
an anode comprising an anode active material; and
an electrolyte.
